(19) United States
(12) Patent Application Publication
(10) Pub. No.: US 2025/0370585 A1
(43) Pub. Date: Dec. 4, 2025

(54) PSEUDO FORCE PRESENTING APPARATUS, PSEUDO FORCE PRESENTINGMETHOD, AND PROGRAM

(71) Applicant: NIPPON TELEGRAPH AND TELEPHONE CORPORATION, Tokyo (JP)

(72) Inventors: Takumi YOKOSAKA, Tokyo (JP); Takahiro KAWABE, Tokyo (JP); Yusuke UJITOKO, Tokyo (JP)

(73) Assignee: NIPPON TELEGRAPH AND TELEPHONE CORPORATION, Tokyo (JP)

(21) Appl. No.: 18/878,016

(22) PCT Filed: Jun. 30, 2022
(86) PCT No.: PCT/JP2022/026208

§ 371 Date: Dec. 21, 2024

(51) Int. Cl. G06F 3/04812; G06T 3/40

(52) U.S. Cl. CPC G06F 3/04812; G06T 3/40

(57) ABSTRACT

A pseudo force sense is implemented without changing the movement trajectory or size of a cursor. A pseudo force sense presentation device for this purpose includes a cursor detection unit, a cursor update unit, and a video display unit. The cursor detection unit detects position information of a cursor as an image displayed on the video display unit for a user to operate a device. The cursor update unit continuously changes and updates the image of the cursor on the basis of the position information. The video display unit presents the cursor whose image has been updated to the user according to the position information.

### TECHNICAL FIELD

The disclosed technique relates to a pseudo force sense presentation technique using an optical illusion, for example, a technique of presenting, to a user, image information that causes an illusion in an operation feeling of a cursor or the like on a computer screen.

### BACKGROUND ART

There is a “pseudo haptic technique” as a technique similar to the pseudo force sense presentation technique.

In the pseudo haptic technique, visual information (such as a cursor) is operated on the basis of position information obtained from an input device (a mouse, a keyboard, a touch pad, a touch pen, a touch panel, a gesture recognition device, a reaction force presentation device, or the like), so that visual feedback in response to the position input is given to a user. At this time, giving a delay or fluctuation to the visual feedback (cursor or the like) and changing the movement trajectory or size thereof makes it possible to provide a haptic impression different from an actual haptic impression to the user in an illusory manner.

### CITATION LIST

### Non Patent Literature

Non Patent Literature 1: Costes et al., Touchy: A Visual Approach for Simulating Haptic Effects on Touchscreens, Frontiers in ICT, February 2019/Vol. 6/Article 1 <https://doi.org/10.3389/fict.2019.00001>

### SUMMARY OF INVENTION

### Technical Problem

Hereinafter, a visual medium displayed on a video display unit (a display, a virtual reality headset, a video projector screen, or the like) of a computing machine (a computer, a smart phone, a tablet, or the like) for a user to operate the computing machine on the basis of position information obtained from an input device is referred to as a “cursor”.

In the conventional pseudo haptic technique, it is necessary to change the movement trajectory or size of a cursor according to a user's operation. There is a problem that changing the movement trajectory or size of an object such as a cursor used for a computing machine operation in a manner independent of the operation hinders the original operation.

### Solution to Problem

In order to solve the above problem, a pseudo force sense presentation device according to the disclosed technique includes a cursor detection unit, a cursor update unit, and a video display unit. The cursor detection unit detects position information of a cursor as an image displayed on the video display unit for a user to operate a device. The cursor update unit continuously changes and updates the image of the cursor on the basis of the position information. The video display unit presents the cursor whose image has been updated to the user according to the position information.

### Advantageous Effects of Invention

According to the disclosed technique, it is possible to implement a device that presents a pseudo force sense to a user without changing the actual drawing position or drawing size of a cursor and thus without hindering an original cursor operation of the user.

### BRIEF DESCRIPTION OF DRAWINGS

FIG. 1 is a diagram for describing a cursor operation according to a first embodiment.

FIG. 2 is a diagram for describing a change in a cursor pattern according to the first embodiment.

FIG. 3 is a diagram for describing a modification of the cursor operation according to the first embodiment.

FIG. 4 is a functional block diagram of a pseudo force sense presentation device according to the first embodiment.

FIG. 5 is a flowchart of an action of the pseudo force sense presentation device according to the first embodiment.

FIG. 6 is a diagram for describing a change in a cursor pattern according to a second embodiment.

FIG. 7 is a diagram for describing a change in a cursor pattern according to a third embodiment.

FIG. 8 is a diagram for describing a cursor operation in Experiment 1.

FIG. 9 is a diagram for describing results of Experiment 1.

FIG. 10 is a diagram for describing a cursor operation in Experiment 2.

FIG. 11 is a diagram for describing results of Experiment 2.

FIG. 12 is a diagram illustrating a functional configuration example of a computer.

### DESCRIPTION OF EMBODIMENTS

Hereinafter, embodiments of the disclosed technique will be described in detail. Note that components having the same functions are denoted by the same reference numerals, and redundant description will be omitted.

### Outline of Disclosed Technique

The disclosed technique is a technique of allowing a user to perceive a pseudo force without modulating the actual display position (movement trajectory) or size of a cursor displayed on a video display unit by using a phenomenon of causing an illusion of the visual position or size of the cursor. Specifically, the technique is capable of causing the user to have an illusion that a force is applied in a direction opposite to a direction in which a pattern is shifted, by using an optical illusion in which, when the pattern of the cursor displayed on the video display unit is gradually shifted and displayed, the user feels as if the cursor itself has moved in a direction opposite to a direction in which the pattern is shifted.

### First Embodiment

### Description of Phenomenon Seen by User

First, how a pseudo force sense is presented on a display will be described by use of a scene where a user operates a cursor using a mouse as an example.

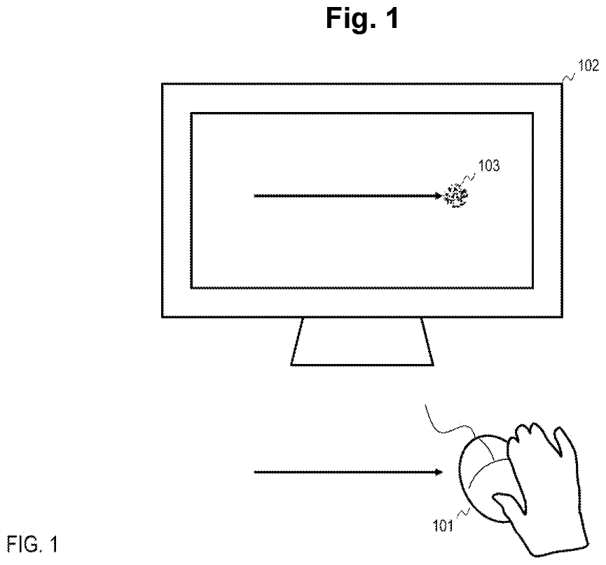

FIG. 1 illustrates an example of a case where a cursor 103 displayed on a display 102 is operated by a mouse 101. As illustrated in FIG. 1, it is assumed that the user operates the mouse such that the cursor moves horizontally in the display.

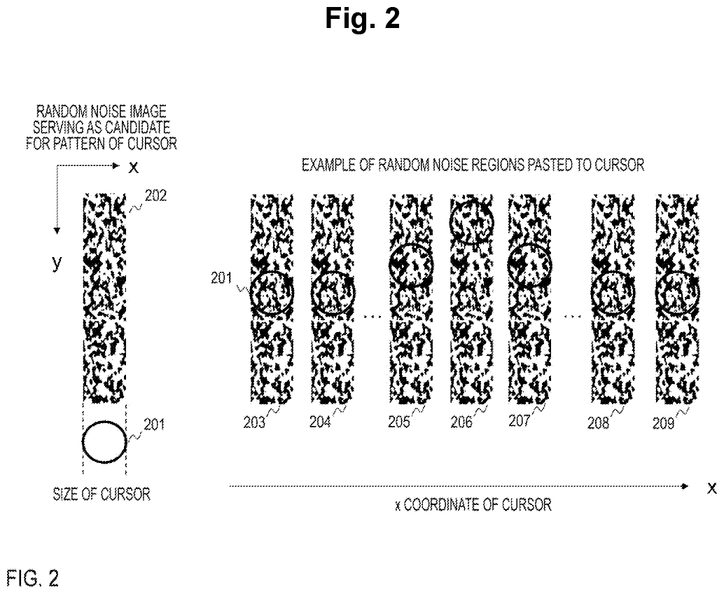

A change in a pattern displayed as a cursor will be described with reference to FIG. 2.

A basic image 202 including a random noise image sufficiently larger than the size of a cursor 201 is prepared. It is assumed that the horizontal and vertical directions of the display 102 correspond to the x-axis and the y-axis of the basic image 202.

An image piece obtained by cutting out a part of the basic image 202 is pasted to the cursor 201. It is shown how the image piece displayed as the cursor changes as the cursor moves from 203 to 209, from left to right (in the positive direction on the x-axis) on the display. In this example, an image piece in the middle of the basic image 202 in the y-axis direction is first displayed as the cursor. However, as the cursor advances along the x-axis, the pattern of the cursor changes so as to gradually display image pieces in an upper part of the basic image 202, and then gradually return to the display of the original image piece in the middle.

At this time, the user sees the cursor moving horizontally and the pattern (random noise pattern) once flowing downward and then flowing upward. Due to this change in the pattern of the cursor, the user has an illusion that the cursor has drawn a convex trajectory, and if the trajectory of the cursor has actually changed, the user has an illusion of a force with which the user should have operated the mouse in such a manner.

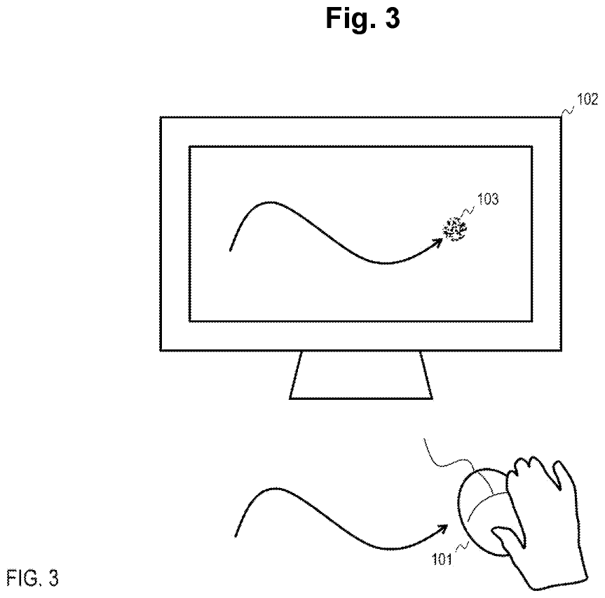

Although the case where the cursor is operated horizontally (parallel to the x-axis) in the display has been described as an example in order to easily obtain an image of a pseudo force sense, it will be apparent that the cursor does not need to move parallel to the x-axis in order to present a pseudo force sense in the y-axis direction. When the cursor moves along the curve as illustrated in FIG. 3, a pseudo force sense can be provided in the y-axis direction if the random noise pattern displayed as the cursor is changed in the same manner as described above with the x coordinate as a variable. Verification of the fact that a human actually has the above-described illusion will be described later.

### Pseudo Force Sense Presentation Device and Presentation Procedure

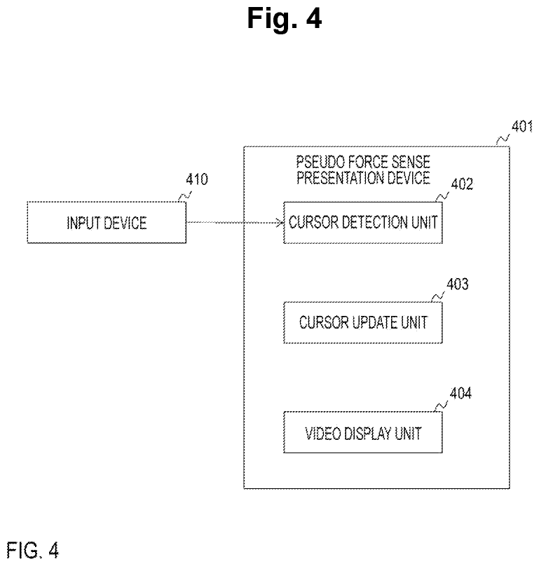

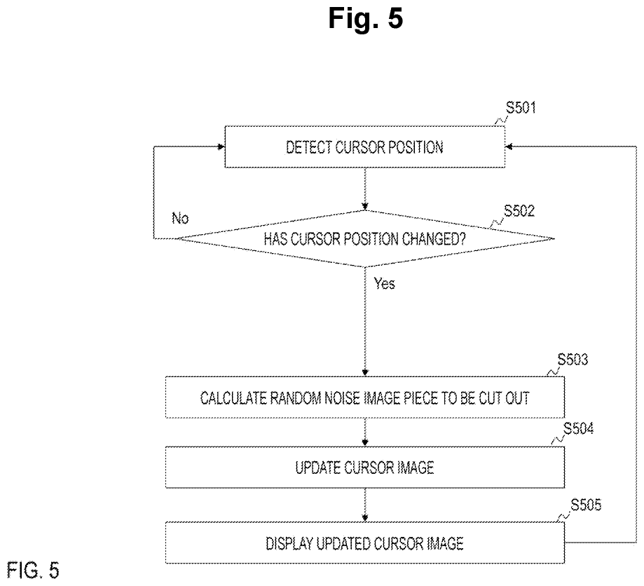

FIG. 4 is a diagram illustrating functional blocks of a pseudo force sense presentation device, and FIG. 5 is a flowchart for describing an action of the pseudo force sense presentation device.

A pseudo force sense presentation device 401 includes at least a cursor detection unit 402, a cursor update unit 403, and a video display unit 404.

The cursor detection unit 402 acquires a signal from an input device 410, and measures where the cursor operated by the user is on the video display unit or where the cursor should be displayed, and detect a cursor position (step S501). Whether or not the cursor has been moved is determined in step S502, and when the cursor position has not changed, the processing returns to step S501 (step S502).

The cursor update unit 403 includes the basic image 202 and a function f that defines the relationship between the position of a cursor and an image piece to be extracted. When the cursor is circular, f can be, for example, a function that gives the center coordinate y of the image piece (circle) with x as a variable.

The cursor update unit 403 calculates a random noise image piece to be cut out from the basic image 202 on the basis of x and f (step S503), and updates the cursor image (step S504).

The video display unit 404 presents the updated cursor to the user (step S505), and the processing returns to step S501.

In the above description, the center of the circular region to be extracted is obtained from the position of the cursor by the function. However, the method of associating the position of the cursor with the region of the image piece is not limited to this. For example, the position of the cursor and the region of the image piece to be extracted may be associated with each other by a table. Note that it is desirable that a change in the pattern of the cursor appears smooth and continuous to human eyes.

### Second Embodiment

In the first embodiment, when the cursor is moved on the display, the random noise pattern is shifted in the vertical direction (y direction) according to the x coordinate and pasted.

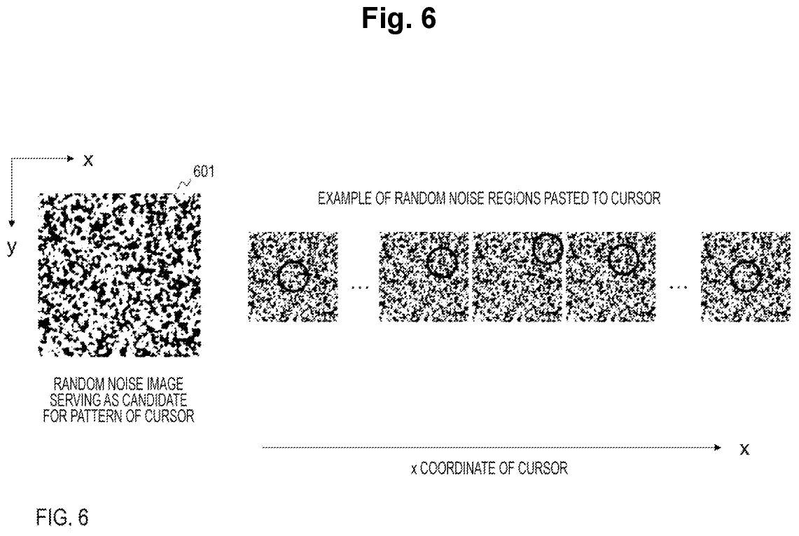

In the second embodiment, a random noise pattern is shifted in the x-y plane according to the x coordinate of a cursor. For example, as illustrated in FIG. 6, an image piece to be extracted is gradually shifted to an upper right region of a basic image. At this time, the user has an illusion that the cursor has been curved to the upper right with respect to the actual trajectory, and perceives a force of pulling in the upper right direction.

In the second embodiment, the cursor update unit 403 in FIG. 4 includes a basic image 601 in FIG. 6 instead of the basic image 202 in FIG. 2. In addition, a function for extracting an image piece is a function for inputting an x coordinate and outputting x-y coordinates. Except for the above, the device configuration and the contents of the action are similar to those of the first embodiment.

### Third Embodiment

In the first embodiment and the second embodiment, the cursor image is changed according to the x coordinate.

In the third embodiment, a cursor image is changed according to the x-y coordinates of a cursor. For example, an image piece is cut out from a random noise pattern enlarged or reduced according to the position of the cursor and pasted to the cursor. This makes it possible to feel a force in the z direction perpendicular to the x-y plane (front-depth direction of the display).

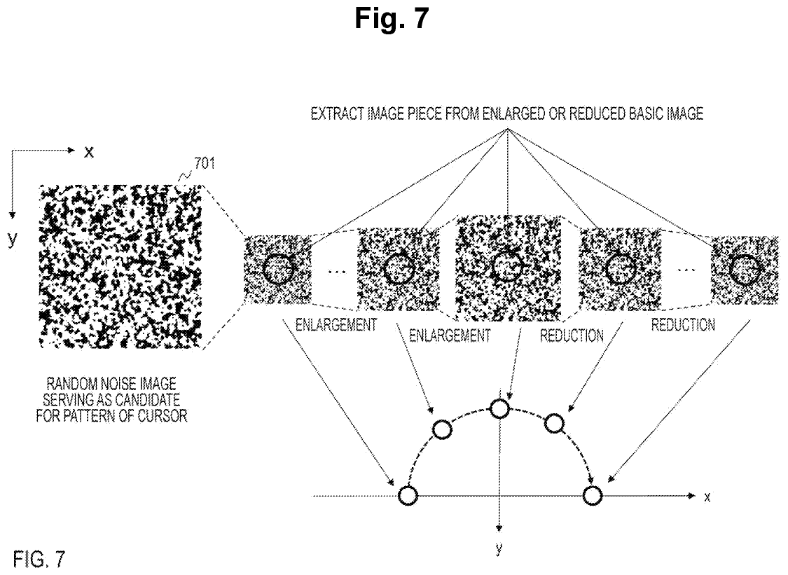

In the third embodiment, the cursor update unit 403 in FIG. 4 includes a basic image 701 in FIG. 7. Furthermore, in the operation of extracting an image piece, the x-y coordinates of the cursor are acquired, the basic image 701 is enlarged or reduced according to the coordinates, and the image piece is extracted. Except for the above, the device configuration and the contents of the action are similar to those of the first embodiment.

Furthermore, although the basic image is enlarged or reduced according to the x-y coordinates of the cursor so that an image piece is extracted in the above third embodiment, the extraction position in the basic image may be changed according to the x-y coordinates of the cursor, or the enlargement or reduction of the basic image and the displacement in the basic image may be combined to extract the image piece.

### Fourth Embodiment

In the first to third embodiments, the basic image is prepared in advance, and the image pieces are extracted from the basic image according to the position of the cursor. However, the image pieces to be pasted to the cursor may be sequentially generated according to the movement of the cursor without preparing the basic image in advance.

The sequentially generated images may be any images that appear smooth and continuous to human eyes when the images are presented to the user as a change in a pattern of the cursor. Examples of the continuous images that can be sequentially generated include a random noise image and a repeated pattern (a checkered pattern, a hexagonal pattern, or the like).

In the fourth embodiment, the cursor update unit in FIG. 4 does not include the basic image, and instead of step S503 of calculating an image piece to be cut out from the basic image, a step of newly generating image pieces in which a change in the cursor pattern presented to the user appears smooth and continuous to human eyes is executed on the basis of the information on the cursor position. Except for the above, the device configuration and the contents of the action are similar to those of the first embodiment.

### Points to be Noted in Presentation to User

It has been experimentally found that, in a case where the visibility of a cursor is high, the degree of perception of a pseudo force sense decreases (described later). Therefore, it is necessary to pay attention to the following points at the time of presenting a cursor to a user.

### Frame Line of Cursor Graphic

It is desirable not to use a frame line for a cursor graphic. Even if the frame line is used, it is desirable that the frame line has luminance substantially equal to the average luminance of a background image.

Pattern of Cursor and Background It is desirable that the background of the cursor and the cursor graphic are similar to each other. For example, it is desirable that both the background and the cursor graphic are random images.

### Pattern Displayed on Cursor

A basic image used for the pattern of the cursor does not need to be a random noise pattern, and may be an image including a picture or a character. In addition, the higher the contrast of the pattern in the cursor, the more clearly the movement of the pattern in the cursor is felt, and the felt force increases.

### Verification of Disclosed Technique

Experiment 1: Pseudo Force Sense Presentation in y-Axis Direction

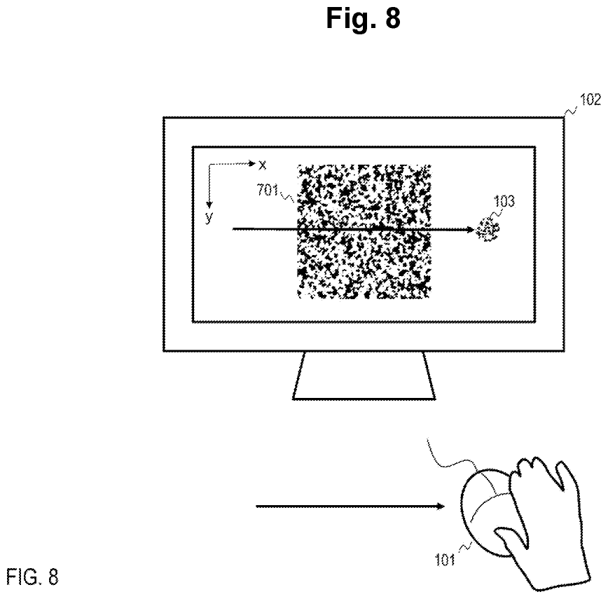

In Experiment 1 in which the disclosed technique was verified, a user moved a cursor with a random noise pattern from the left end (or right end) to the right end (or left end) of a screen using a mouse as illustrated in FIG. 8, and it was evaluated by an evaluation method how strongly the user felt that an unintended large force was applied upward or downward to the cursor in the middle of the movement. Specifically, the evaluation was performed by a method of three choices of 1: no force was felt, 2: a weak force was felt, and 3: a large force was felt.

Note that a pseudo force sense was presented when the cursor moved on the random noise background 701 simultaneously displayed on the display 102. When passing over the random noise background 701 in the center of the screen, the random noise pattern in the cursor was slid in the y-axis direction with a deflection (noise drift value) having a maximum value of any one of −7.0, −5.25, −3.5, −1.75, 0.0, 1.75, 3.5, 5.25, and 7.0 mm.

For each noise drift value, an experiment of presenting a pseudo force sense was performed four times for 48 experiment participants, and their responses were obtained. For each experiment participant, the average of four responses was taken, and 48 samples were obtained at each noise drift value.

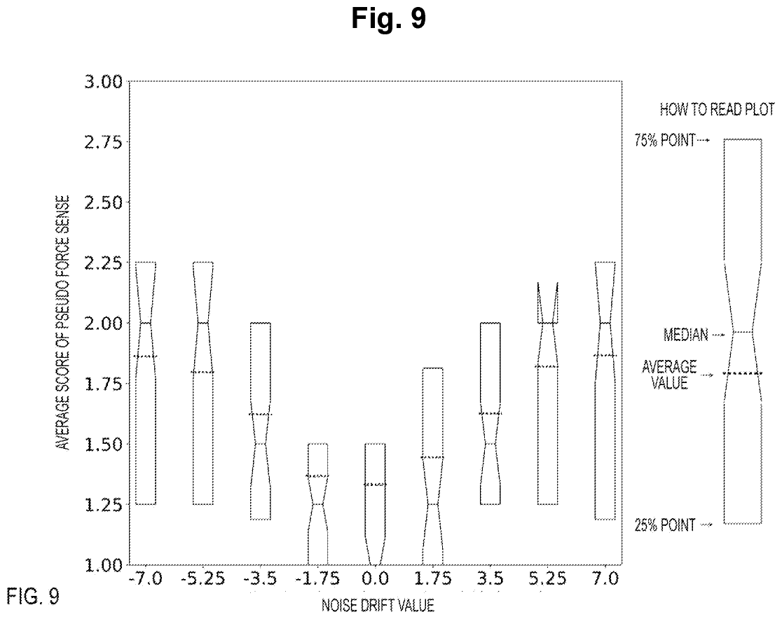

FIG. 9 illustrates the distribution (box plot) of the evaluation results. The horizontal axis represents the noise drift value, the vertical axis represents the average score of the subjects, the upper limit of a box represents the 75% point, the lower limit of a box represents the 25% point, the center of a constriction represents the median, and a dotted line represents the average value.

It is shown that the experiment participants felt that a larger force was applied to the cursor as the absolute value of the shift amount of the random noise pattern was larger.

Note that a constriction that interposes the median of a plot represents the 95% confidence interval of the median, and the reason why the upper part of the plot is folded back at the noise drift value 5.25 is that the median and the 75% point coincide with each other and the 75% point falls below the upper limit of the 95% confidence interval.

### Experiment 2: Relationship Between Visibility of Cursor and Pseudo Force Sense

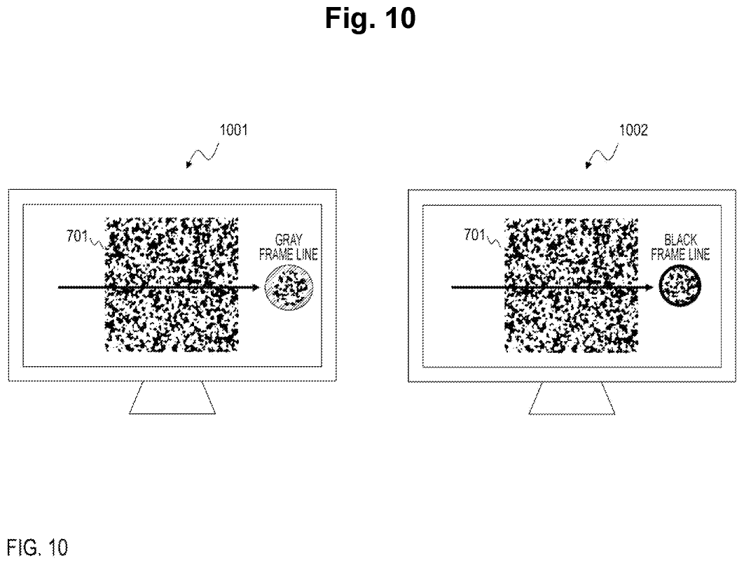

In Experiment 2, two conditions of black and gray were prepared for luminance of a circular frame surrounding a cursor. As illustrated in 1001 and 1002 in FIG. 10, a pseudo force sense is presented when each of a cursor with a gray frame line and a cursor with a black frame line passes over the random noise background 701. Note that the diagonal line pattern surrounding the cursor in 1001 means the “gray frame line”.

This is because it is known that, as the contrast between a cursor and a background decreases, that is, as the visibility deteriorates, a position illusion of the cursor that is stopped becomes stronger due to the random noise shift, and it is considered that the visibility is also important for a trajectory change illusion of a moving cursor. When the circular frame surrounding the cursor is gray, which is the average luminance of the random noise of the background, the visibility is the worst, and when the frame is black or white, the visibility is the best.

In addition to the two conditions of luminance of the circular frame, three conditions of 0, 3.5, and 7.0 mm were prepared for the shift amount of the random noise pattern in the cursor. The same experiment as Experiment 1 was performed under a total of six conditions. For each condition (three conditions of noise drift×two conditions of visibility), an experiment of presenting a pseudo force sense was performed six times for 126 experiment participants, and their responses were obtained by use of a method of three choices. The average of six responses was taken for each experiment participant to obtain 126 samples in each condition.

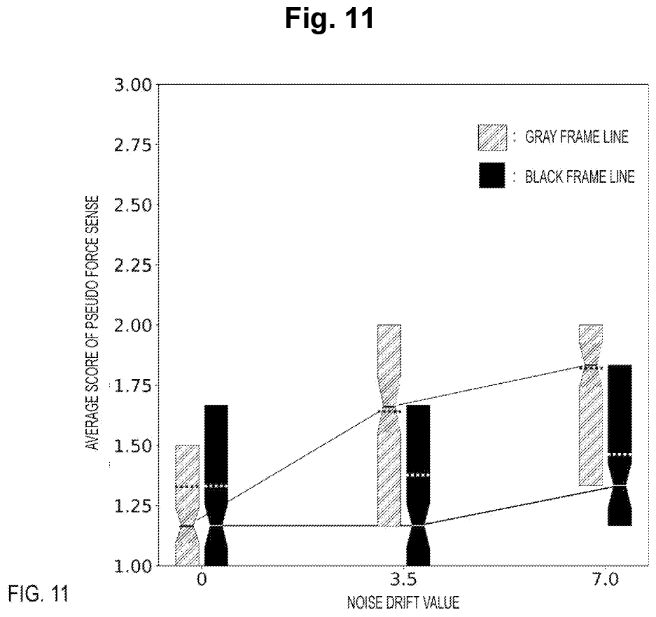

FIG. 11 illustrates the results of Experiment 2. The shift amount of the random noise pattern in the cursor is plotted on the horizontal axis, and the average value of the evaluation values for each individual is plotted on the vertical axis. The gray bar and the black bar each represent the luminance of a circular frame surrounding the cursor.

It was found that, in the case of the gray frame with poor visibility, the experiment participants felt that a larger force was applied as the shift amount of the random noise pattern in the cursor increased, as in Experiment 1. On the other hand, it was shown that, in the case of the black frame with good visibility, the force felt by the experiment participants did not increase even when the shift amount of the random noise pattern in the cursor increased.

### Program and Recording Medium

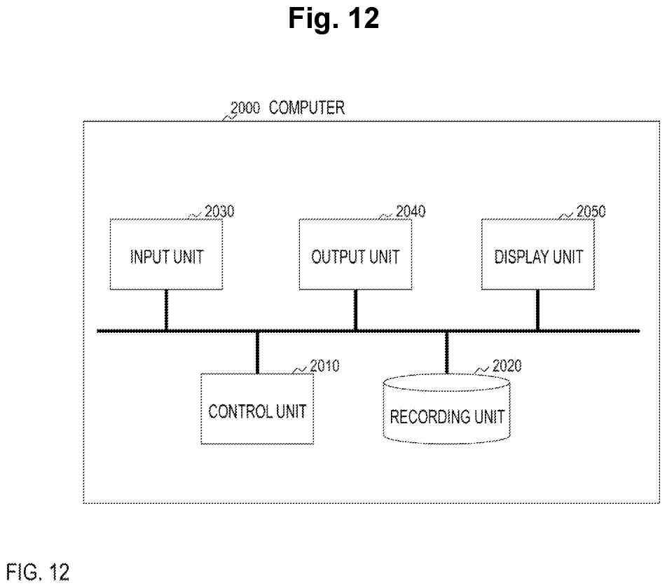

The various types of processing described above can be performed by causing a recording unit 2020 of a computer 2000 illustrated in FIG. 12 to read a program for executing each step of the method described above and causing a control unit 2010, an input unit 2030, an output unit 2040, a display unit 2050, and the like to operate.

The program in which the processing contents are described can be recorded on a computer-readable recording medium. The computer-readable recording medium may be any recording medium such as a magnetic recording device, an optical disk, a magneto-optical recording medium, or a semiconductor memory, for example.

Furthermore, distribution of the program is performed by, for example, selling, transferring, or renting a portable recording medium such as a DVD or a CD-ROM on which the program is recorded. Moreover, the program may be stored in a storage device of a server computer, and the program may be distributed by being transferred from the server computer to another computer via a network.

For example, a computer that executes such a program first temporarily stores a program recorded on a portable recording medium or a program transferred from a server computer in a storage device of the computer. When executing processing, the computer reads the program stored in the recording medium of the computer and executes the processing according to the read program. In addition, as another mode of executing the program, the computer may read the program directly from the portable recording medium and execute the processing according to the program, or may sequentially execute processing according to a received program every time the program is transferred from the server computer to the computer. Moreover, the above-described processing may be executed by a so-called application service provider (ASP) type service that implements a processing function only by an execution instruction and result acquisition without transferring the program from the server computer to the computer. Note that the program in the present mode includes information that is used for processing by an electronic computing machine and is equivalent to the program (data or the like that is not a direct command to the computer but has a property that defines processing performed by the computer).

In addition, although the present device is configured by the predetermined program being executed on the computer in this mode, at least a part of the processing contents may be implemented by hardware.

1. A pseudo force sense presentation device comprising:
a cursor detection unit that detects position information of a cursor as an image displayed on a video display unit for a user to operate a device;
a cursor update unit that continuously changes and updates the image of the cursor on a basis of the position information; and
the video display unit that presents the cursor whose image has been updated to the user according to the position information.

2. The pseudo force sense presentation device according to claim 1, wherein
the cursor update unit includes a basic image larger than the cursor, and updates the image of the cursor using an image piece extracted from the basic image on a basis of the position information.

3. The pseudo force sense presentation device according to claim 2, wherein
the cursor update unit updates the image of the cursor by enlarging or reducing the basic image and extracting the image piece on a basis of the position information.

4. The pseudo force sense presentation device according to claim 1, wherein
the cursor update unit updates the image of the cursor by newly generating an image piece on a basis of the position information and using the newly generated image piece.

5. A pseudo force sense presentation method comprising:
detecting position information of a cursor as an image displayed on a video display unit for a user to operate a device;
changing and updating the image of the cursor on a basis of the position information; and
providing the cursor whose image has been updated to the user according to the position information.

6. (canceled)

7. The pseudo force sense presentation method according to claim 5, wherein
the image of the cursor is updated using an image piece extracted from the basic image on a basis of the position information.

8. The pseudo force sense presentation method according to claim 7, wherein
the image of the cursor is updated by enlarging or reducing the basic image and extracting the image piece on a basis of the position information.

9. The pseudo force sense presentation method according to claim 5, wherein
the image of the cursor is updated by newly generating an image piece on a basis of the position information and using the newly generated image piece.

10. A computer-readable non-transitory recording medium storing computer-executable program instructions that when executed by a processor cause a computer to execute a pseudo force sense presentation method comprising:
detecting position information of a cursor as an image displayed on a video display unit for a user to operate a device;
changing and updating the image of the cursor on a basis of the position information; and
providing the cursor whose image has been updated to the user according to the position information.

11. The computer-readable non-transitory recording medium according to claim 10 wherein the pseudo force sense presentation method further comprises:
updating the image of the cursor using an image piece extracted from the basic image on a basis of the position information.

12. The computer-readable non-transitory recording medium according to claim 11 wherein the pseudo force sense presentation method further comprises:
updating the image of the cursor by enlarging or reducing the basic image and extracting the image piece on a basis of the position information.

13. The computer-readable non-transitory recording medium according to claim 10 wherein the pseudo force sense presentation method further comprises:
updating the image of the cursor by newly generating an image piece on a basis of the position information and using the newly generated image piece.
